(19) United States
(12) Patent Application Publication
(10) Pub. No.: US 2013/0179558 A1
(43) Pub. Date: Jul. 11, 2013

(54) SERVER MANAGEMENT USING A BASEBOARD MANAGEMENT CONTROLLER TO ESTABLISH A WIRELESS NETWORK

(71) Applicants: Jing Lin, Shanghai (CN); Bo Xie, Shanghai (CN); Jian Xu, San Jose, CA (US); Binqi Zhang, Shanghai (CN)

(72) Inventors: Jing Lin, Shanghai (CN); Bo Xie, Shanghai (CN); Jian Xu, San Jose, CA (US); Binqi Zhang, Shanghai (CN)

(73) Assignee: INTERNATIONAL BUSINESS MACHINES CORPORATION, Armonk, NY (US)

(21) Appl. No.: 13/822,315

(22) PCT Filed: Sep. 9, 2011
(86) PCT No.: PCT/EP2011/065634

§ 371 Date: Mar. 12, 2013

(30) Foreign Application Priority Data
Sep. 30, 2010 (CN) 201010297787.4

(51) Int. Cl. H04W 8/00

(52) U.S. Cl. CPC H04W 8/00
USPC 709/223

(57) ABSTRACT

A server management system and a method for server management, wherein the server management system comprises baseboard management controllers (BMCs) located at each of a plurality of servers, wherein each BMC comprises: a connection establishment interface component configured to establish connection with one processing device in response to a request of establishing connection with the processing device and to receive a server management instruction from the processing device; and a wireless network communication component configured to enable the BMCs to establish a wireless network through their wireless network communication component; wherein, the server that establishes connection with the processing device is designated as an interface server, and the wireless network communication component of the BMC of the interface server is further able to broadcast the server management instruction received by the connection establishment interface component to managed servers via the established wireless network.

### BACKGROUND

1. Field of the Invention

Embodiments of the present invention relate to methods and systems for server management.

2. Background of the Related Art

In an enterprise's data center, there are usually multiple servers that are managed by a system administrator using special system management software. FIG. 1 shows the architecture of an existing data center server management in which one managing server and multiple managed servers are included. The managing server and all of the managed servers may be in a production network and provide services for the enterprise, or a management network and a production network may be separate. FIG. 1 shows an implementation in which a management network and a production network are separate, such that security and manageability are better.

A management network usually employs an Ethernet. Servers connected to the management network, including the managing server and each of the managed servers, are first wired physically to be inter-connected as the management network and then the administrator needs to configure the network. Afterwards, management software is installed and then executed. Existing system management software, including a server-side and a client-side of the management software, is usually installed after an operating system is installed, wherein the server-side of the management software is installed in the managing server and the client-side of the management software is installed in the managed servers. The system administrator communicates with the client software installed at the managed servers through programs such as a user interface (UI) of the server-side of the management software at the managing server so as to manage the managed servers. The management functions include monitoring, information collecting, diagnosing, information distributing, firmware updating and other aspects of the managed servers. The information required for the management functions is generally obtained within the operating systems of the managed servers.

Generally speaking, there is, on each server, one Baseboard Management Controller (BMC) which is one chip that is integrated on the circuit board of the server and able to obtain environment variable data of the server on which it is located via a sensor and to report the data to the operating system via a management interface. Furthermore, the operating system may obtain environment variable data of the server in many other ways, for example via hardware device driver programs, I/O invoking programs and so on.

In addition, the baseboard management controller itself has a management interface and a separate network interface which is connected to the management network, and may communicate with the server-side of the management software of the managing server directly via the management network, so as to realize a certain management function, such as information collecting, firmware updating, etc., to the managed servers by the managing server. Such a management function does not require participation of operating systems of the managed servers, and under such architecture of the managing server, the managing server itself is independent of the baseboard management controller. However, if the managing server itself is established on a virtual server, when the physical server itself on which the managing server is based is also a managed server, the baseboard management controller is also needed to manage the physical server.

### BRIEF SUMMARY

One embodiment of the present invention provides a server management system for managing a plurality of servers, wherein the server management system comprises baseboard management controllers located at each server. Each of the baseboard management controllers comprises a connection establishment interface component and a wireless network communication component. The connection establishment interface component is configured to establish a connection with a processing device in response to a request of establishing connection with the processing device, and to receive a server management instruction from the processing device. The wireless network communication component is configured to enable the baseboard management controllers of the plurality of servers to establish a wireless network through the respective wireless network communication component. The server that establishes a connection with the processing device is designated as an interface server of the server management system, and the wireless network communication component of the baseboard management controller of the interface server broadcasts the server management instruction received by the connection establishment interface component to managed servers via the established wireless network.

Another embodiment of the present invention provides a method for server management. Each of a plurality of servers has a baseboard management controller, and each baseboard management controller has a wireless network communication component. The baseboard management controllers of the plurality of servers use their wireless network communication component to establish a wireless network. The method comprises: establishing, by the baseboard management controller of any one of the plurality of servers, connection with one processing device in response to a request of establishing connection with the processing device; designating the server including the baseboard management controller that establishes connection with the processing device as an interface server; and receiving, by the interface server, a server management instruction from the processing device, and broadcasting, by the interface server, the received server management instruction to managed servers via the established wireless network.

### BRIEF DESCRIPTION OF THE SEVERAL VIEWS OF THE DRAWINGS

The above and other objects, features and advantages of the present invention will become more distinct through a more detailed description of exemplary embodiments of the present invention in attached drawings, in which identical reference numbers denote the same components in exemplary embodiments of the present invention. Embodiments of the present invention can be realized in various forms and should not be understood as being limited by the embodiments illustrated.

FIG. 1 is a diagram of server management of a data center using an existing architecture.

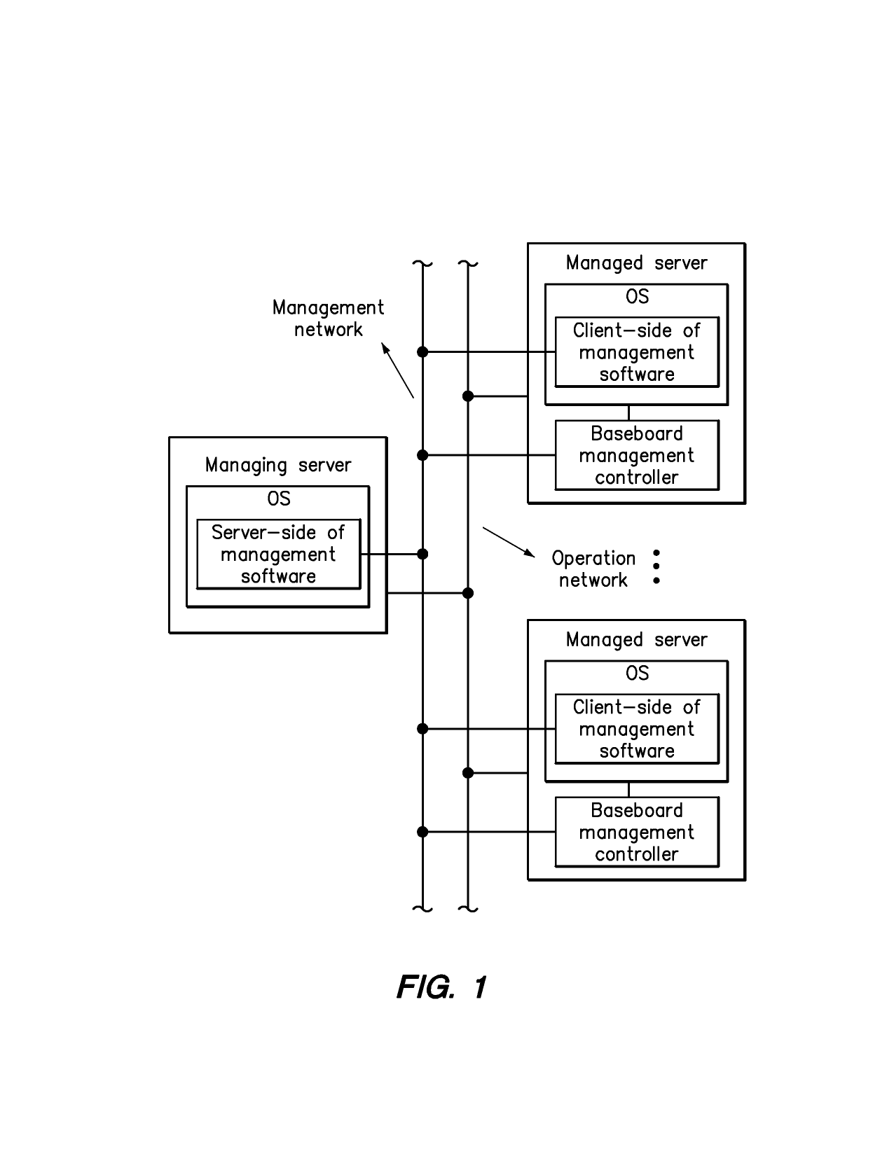

FIG. 2 is a diagram of a server management system according to one embodiment of the present invention.

FIG. 3 is a flow chart of a server management method according to one embodiment of the present invention.

### DETAILED DESCRIPTION

One embodiment of the present invention provides a server management system for managing a plurality of servers, wherein the server management system comprises baseboard management controllers located at each server, and each of the baseboard management controllers comprises: a connection establishment interface component or device that is configured to establish connection with one processing device in response to a request of establishing connection with the processing device and to receive a server management instruction from the processing device; and a wireless network communication component or device that is configured to enable the baseboard management controllers of the plurality of servers to establish a wireless network through the wireless network communication component on them; wherein, the server that establishes connection with the processing device is designated as an interface server of the server management system, and the wireless network communication component of the baseboard management controller of the interface server is further able to broadcast the server management instruction received by the connection establishment interface component to managed servers via the established wireless network.

Another embodiment of the present invention provides an interface server in a server management system for managing a plurality of servers including the interface server, wherein the interface server has a baseboard management controller which comprises: a connection establishment interface component that is configured to establish connection with a processing device in response to a request of establishing connection with the processing device and to receive a server management instruction from the processing device; and a wireless network communication component; wherein, the wireless network communication component of the baseboard management controllers of the plurality of servers are configured to establish a wireless network, and the wireless network communication component of the baseboard management controller of the interface server is further able to broadcast the server management instruction received by the connection establishment interface component to managed servers via the established wireless network.

A further embodiment of the present invention provides a method for server management, wherein each of a plurality of servers has a baseboard management controller, and the baseboard management controller has a wireless network communication component, and the baseboard management controllers of the plurality of servers establish a wireless network through the wireless network communication component on them, the method comprising: establishing, by the baseboard management controller of any one of the plurality of servers, connection with one processing device in response to a request of establishing connection with the processing device; designating the server that establishes connection with the processing device as an interface server; and receiving, by the interface server, a server management instruction of the processing device and broadcasting, by the interface server, the received server management instruction to managed servers via the established wireless network.

With the present invention, it is noted that existing baseboard management controllers have a feature that the baseboard management controller can work even if the server is not turned on as long as the server is AC power-cycled (connected to a power line without initiating a power button). Thus, if some modification is made on the existing baseboard management controller, a new server management scheme for a data center can be produced.

Specifically, a function of wireless communication may be added to the baseboard management controller such that baseboard management controllers of all servers constitute a wireless network which itself is separated from the operation network and can work without wiring of the management network, starting of the server and running of the operating system as long as the server is AC power-cycled. Then, all servers are managed by using one device which may be a handheld device or a fixed device or even one server thereof. Here, we call the device as a processing device in order to distinguish it from the managing server under the server management architecture of the existing data center. The processing device is connected with a selected one of the multiple baseboard management controllers constructing the wireless network. There are a variety of manners of such connection, for example, one or more of communication through a static wireless network protocol, such as a static wireless local area network supported by IEEE 802.11, or communication through dynamic wireless network protocol, such as a dynamic wireless network protocol supported by IEEE 802.15.4, or even connection via USB or Bluetooth or infrared and so on. Any wireless connection technology may be employed.

Since there is only one processing device which is connected to the baseboard management controller of one server selected by it, transmission distance in the data center can be controlled to be within transmission distance limits of these conventional wireless protocols, and there is no strict requirements on bandwidth for transmission of server management instructions because management instructions, policies and result data are usually not big in size. In this way, the processing device can manage all of the servers through its randomly selected baseboard management controller. Here, a USB may use a wireless USB, and may use even a wired USB in a special case, for example, when the processing device is very close to an interface server physically.

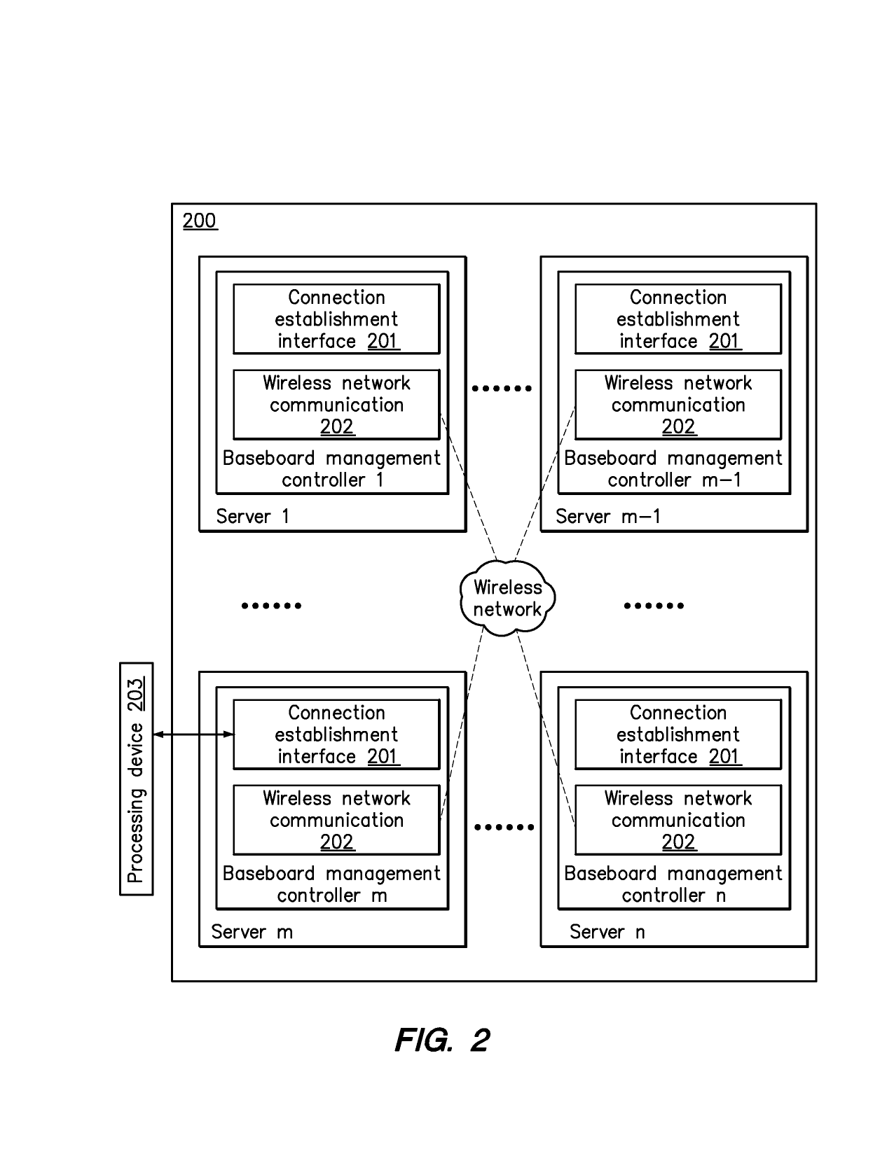

FIG. 2 is a diagram of a server management system 200 for managing multiple servers in accordance with one embodiment of the present invention. According to FIG. 2, the server management system 200 manages multiple servers, for example server 1 to server m-1, server m and server n, wherein both m and n are integers larger than 1 and n is larger than m. The server management system includes baseboard management controllers located at each of the servers. In other words, each of the multiple servers has a baseboard management controller, for example, baseboard management controller 1 to baseboard management controller m-1, baseboard management controller m, and baseboard management controller n, wherein both m and n are integers larger than 1 and n is larger than m.

Each of baseboard management controllers includes a connection establishment interface component 201 and a wireless network communication component 202. The connection establishment interface component 201 is configured to establish a connection with the processing device 203 in response to a request for establishing a connection with the processing device and to receive a server management instruction from the processing device 203. The wireless network communication component 202 is configured to enable the baseboard management controllers of the multiple servers to establish a wireless network through the wireless network communication component on them. The server that establishes connection with the processing device is designated as the interface server of the server management system, and the wireless network communication component of the baseboard management controller of the interface server can also broadcast the server management instruction received by the connection establishment interface component to the managed servers via the established wireless network. The management instruction herein may be defined by a user according to the management content as desired, may be defined with reference to the existing server management instruction, and may be extended or modified as desire.

In one option, the interface server itself may possibly also be a managed server. Such a management system is connected via a wireless network and does not need to be like the existing management system which needs to deploy management network wires at first, turn on servers and install operating systems, management software and so on. Since the baseboard management controllers can work upon each of the servers that have a power cabled plugged (AC power-cycled, not necessarily powered on), and since a wireless network can be automatically established, such that connection and communication with the processing device can be established, thus management of servers may be performed and a lot of efforts and resources may be saved. Even if the servers are in an operating state, these management operations do not influence operation of the servers, and there is no need to intervene the operating systems of the servers or to avoid the use of the management software.

In one embodiment, a managed server responds to the server management instruction by sending a response to the wireless network communication component of the baseboard management controller within the interface server. Then, in response to receiving the response, the wireless network communication component of the baseboard management controller within the interface server forwards the response to the processing device. Here, the response includes the receipt of management instruction, returning a result of the management instruction, or other communication contents.

The wireless network established by the baseboard management controllers of the multiple servers via the wireless network communication component has a certain requirement on communication distance and speed due to performing communication related to management, and since the baseboard management controllers are located inside of the servers, communication thereof may use a wireless static network or a wireless dynamic network.

In an embodiment using a wireless static network, a static wireless local area network supported by IEEE 802.11a, IEEE 802.11b, IEEE 802.11g or IEEE 802.11n protocols may be used. The static wireless network needs an access point. After each of the servers is AC power-cycled, the wireless network communication component on its baseboard management controller make a request to the access point, to join the network. After the access point authenticates and grants, the wireless network communication component on the baseboard management controller joins the static wireless network and is associated with the access point. The specific join procedure is known to those skilled in the art, and network communication procedures provided in the above protocols including active scanning and passive scanning, authentication and so on may be referenced, and the description thereof is omitted here. After being associated with the access point, the wireless network communication component on the baseboard management controller has all the access functions of the wireless network and may track positions of wireless network communication component on other baseboard management controllers and send messages to wireless network communication component on other baseboard management controllers, or broadcast messages through the access point in the static wireless network. Therefore, the wireless network communication component on the baseboard management controller of the interface server of the server management system may broadcast the management instruction received from an external device to the wireless network communication component on the baseboard management controller of at least any one server in the static wireless network, and may also receive the execution result of the management instruction from the wireless network communication component on the baseboard management controller of the at least any one server. Use of a static network needs only deployment of the network wires of an access point, which greatly saves workload and cost of management, compared with the prior art that required all servers to deploy management network wires.

In an embodiment using a wireless dynamic network, a dynamic wireless network supported by IEEE 802.15.4 protocols may also be used. After each server is AC power-cycled, the wireless network communication component on that server's baseboard management controller scans the network to determine whether there is an existing dynamic wireless network. If it is determined that there is an existing dynamic network, the wireless network communication component joins the existing dynamic wireless network, otherwise the wireless network communication component creates a dynamic wireless network.

When creating the dynamic network, the wireless network communication component on the baseboard management controller of the server, as a coordinator of the network, broadcasts a beacon containing a dynamic Personal Area Network (PAN) Identity (ID). The wireless network communication component on the baseboard management controller of other servers receive the beacon and may request to join the network as a routing or terminal device. If the request is successful, an address of 16 bits will be received from the beacon sender as the address of the wireless network communication component on the baseboard management controller of the server in the Personal Area Network. Meanwhile, the beacon sender, as an authentication center and a network channel administrator of the Personal Area Network, maintains a route table in the wireless network communication component on the baseboard management controller for propagating messages in the Personal Area Network. Specifically, detailed provisions in IEEE 802.15.4 protocols are known for those skilled in the art.

After the Personal Area Network is established, the wireless network communication component on the baseboard management controller of any one server, after being connected with the processing device as described above, broadcasts the management instruction received by it from an external device to the wireless network communication component on the baseboard management controller of at least any one server in the Personal Area Network and may receive the execution result of the management instruction from the wireless network communication component on the baseboard management controller of the at least any one server. Use of a dynamic wireless network does not even need deployment of an access point, and, compared with a static wireless network, further saves cost for management.

In one embodiment, the interface server may also send the execution result of the management instruction to a designated receiver at a designated frequency in a designated way, for example, may send to the designated receiver in a way of e-mail, short message, multimedia message and the like, maybe once an hour or a day, and so on. The designated receiver may be configured by a user or set in a file or the like. Of course, such transmission requires a corresponding support for that type of transmission. For example, if it is sent in a way of mail and if the baseboard management controller itself does not support mail, the interface server is required to initiate a mail system.

In the above server management system, the server management instruction may include, for example, one or more of a firmware update, system configuration, information collection and so on.

Firmware refers to a software program located in a chip on the server hardware. Server manufacturers issue updates of the firmware, generally including remedy for defects of the firmware program and new functions, at regular intervals. These new functions sometimes influence directly whether a hardware configuration of the server is able to work normally, for example, a central processing unit with a new specification, a memory with a new specification, and even a new operating system and so on. The firmware version when the server is leaving the factory is often not the latest one. Accordingly, the original firmware may not support some new hardware configurations or operating systems and may have certain program defects and so on. Therefore, implementing updates of the firmware version is very important for normal operation of the server and is one of crucial tasks of server management. A typical example of a firmware includes the Basic Input Output System (BIOS).

Firmware updating of at least one server in the system, before the server starts, may be performed by the above server management system. After the processing device broadcasts an instruction, a receiving server, upon receiving the instruction, requests an updated firmware version to be sent. The processing system sends the update firmware version after receiving the request via the interface server, and then receives the execution result of the instruction (i.e. the execution result of firmware update). In this way, the server after firmware update can use the firmware with a new version to start. The system configuration procedure is similar except that it is system configuration information that is sent therein.

In the execution procedure of an instruction for information collection, after the processing device broadcasts the instruction for information collection, the receiving server, upon receiving the instruction, returns a response satisfying the requirement of the instruction back and then sends the collected information to the processing device according to the requirement of the instruction. Non-limiting examples for information collection include collection of information such as available space on a hard disk, temperature of a central processing unit, use of a port and so on, and collections of various physical parameters of the server.

Using the management system of the present invention does not require a managed server to physically deploy management network wires, or install or initiate an operating system, but only requires the managed servers to be AC power-cycled, so that the baseboard management controllers thereon can work normally, are able to receive server management instructions via the connection establishment interface component thereon, and transmit the management instructions and responses as well as execution results of the instructions etc., via the wireless network communication component. In this way, server management of the data center can be greatly simplified and the cost of server management is reduced.

Consistent with the foregoing description, embodiments of the present invention further include an interface server in a server management system for managing multiple servers including the interface server. The interface server has a baseboard management controller which includes a connection establishment interface component and a wireless network communication component. The connection establishment interface component is configured to establish a connection with a processing device in response to a request of establishing a connection with the processing device and to receive a server management instruction from the processing device. The wireless network communication component of the baseboard management controllers of the multiple servers are configured to establish a wireless network, and the wireless network communication component of the baseboard management controller of the interface server can further broadcast the server management instruction received by the connection establishment interface component to the managed servers via the establish wireless network.

The interface server acts as an interface for the processing device issuing the management instruction to the whole server management system. In one embodiment, the wireless network communication component of the baseboard management controller of the interface server can further, in response to receiving a response of a managed server to the management instruction, forward the response to the processing device.

In one embodiment, the wireless network communication component on the baseboard management controller supports a static wireless local area network protocol or a dynamic Personal Area Network protocol or both of them. Specific establishment procedures for the static wireless local area network or the dynamic Personal Area Network have been described before and the description thereof is omitted here. In another embodiment, since the processing device itself may be a fixed device or a handheld device, the way by which it is connected with the interface server may be very flexible. For example, the way by which the interface server establishes connection with the processing device may be one or more of static wireless local area network, dynamic Personal Area Network, Bluetooth, USB or infrared. A suitable way of connection may be selected in accordance with requirements of communication distance, communication speed and so on.

Moreover, the interface server may further send the execution result of the management instruction to a designated receiver at a designated frequency in a designated way. Here, management contents of the server management instruction may include one or more of a firmware update, system configuration or information collection. When servers of the server management system are running, the contents that can be managed are greater. A user may define the management instruction depending on requirements.

Further embodiments of the invention, consistent with the foregoing description, include a method for server management in which each of the multiple servers has a baseboard management controller on which there is a wireless network communication component. The baseboard management controllers of the multiple servers establish a wireless network via the wireless network communication component.

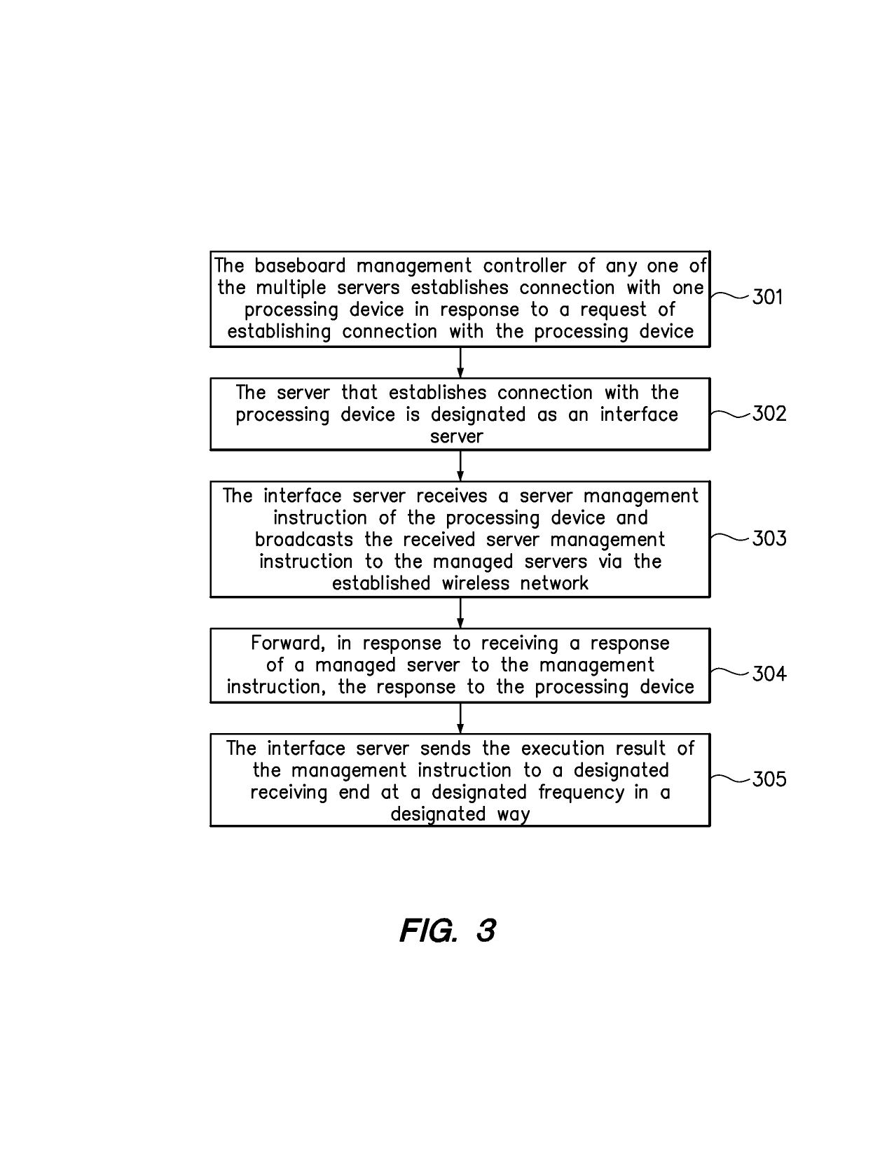

FIG. 3 is a flow chart of a method for server management according to one embodiment of the invention. In step 301, the baseboard management controller of any one of the multiple servers establishes a connection with a processing device in response to a request of establishing a connection with the processing device. In step 302, the server that establishes connection with the processing device is designated as an interface server. In step 303, the interface server receives a server management instruction from the processing device and broadcasts the received server management instruction to the managed servers via the established wireless network. Preferably, the method further includes step 304 of the interface server forwarding, in response to receiving a response to the management instruction from a managed server, the response to the processing device. Preferably, the embodiment shown in FIG. 3 further includes step 305 in which the interface server sends the execution result of the management instruction to a designated receiver at a designated frequency in a designated way.

In one embodiment, the wireless network communication component on a baseboard management controller supports one or more wireless communication protocols such as static wireless local area network protocols or dynamic Personal Area Network protocols. In another embodiment, the way by which the interface server establishes connection with the processing device is one or more of static wireless local area network, dynamic Personal Area Network, Bluetooth, USB or infrared. Here, contents of the server management include firmware update, system configuration or information collection.

Although exemplary embodiments of the present invention are described with reference to attached drawings here, it should be understood that the invention is not limited to these specific embodiments, and those skilled in the art can make various variations and modifications to these embodiments without departing from the scope and principle of the invention. All of these variations and modifications are intended to be included in the scope of the present invention defined in attached claims.

According to the above description, it is known for those skilled in the art that the present invention may be embodied as component, methods or computer program products. Thus, the present invention may be specifically implemented as forms of full hardware, full software (including firmware, resident software, microcode, etc.), or a combination of a software part and a hardware part which is generally referred to as “circuit”, “module” or “system” in the present document. Furthermore, the present invention may be in a form of computer program products embodied in any corporeal medium of expression in which computer useable program codes are included.

Any combination of one or more computer usable or computer readable medium may be employed. A computer usable or computer readable medium for example may be, but not limited to, electrical, magnetic, optical, electromagnetic, infrared, or semiconductor system, apparatus, device or propagation medium. More specific examples (non-exhaustive list) for computer readable media include: electrical connection with one or more wires, portable computer disk, hard disk, Random Access Memory (RAM), Read Only Memory (ROM), Erasable Programmable Read Only Memory (EPROM or flash memory), fiber, portable Compact Disk-Read Only Memory (CD-ROM), optical storage device, transmission medium supporting such as Internet or intranet, or magnetic storage device. It should be noted that a computer usable or computer readable medium may be even a sheet with programs printed thereon or other suitable media, because programs may be obtained electronically by electronic scanning of such a sheet or other media and are then compiled, interpreted or processed in a suitable manner, and, if necessary, are stored in a computer memory. In context of the present document, a computer usable or computer readable medium may be any medium containing, storing, conveying, propagating or transmitting programs which are used by or associated with an instruction execution system, apparatus or device. Computer usable media may include data signals which are in base band or propagated as a part of carrier and embodies computer usable program codes. Computer usable program codes may be transmitted using any suitable media including, but not limited to, wireless, wire, optical cable, RF, etc.

Computer codes for executing operations of the present invention may be wrote in any combination of one or more programming language(s) including object-oriented programming languages such as Java, Smalltalk and C++ and conventional procedural programming languages such as “C” programming language or similar programming languages. Program codes may be executed completely on the computer of a user, partially on the computer of a user, as a separate software package, partially the computer of a user and partially on a remote computer, or completely on a remote computer or server. In the latter situation, the remote computer may be connected to the computer of the user via any kinds of networks including Local Area Network (LAN) or Wide Area Network (WAN), or may be connected to an external computer (for example, via Internet by component of Internet service providers).

Furthermore, each block of the flow chart and/or block diagrams as well as combinations of respective blocks in the flow chart and/or the block diagrams of the present invention may be implemented by computer program codes. These computer program codes may be provided to processors of general purpose computers, specific computers or other programmable data processing apparatuses so as to produce, through these instructions executed by computers or other programmable data processing apparatuses, a machine that produces component implementing functions/operations specified in the blocks of flow chart and/or the block diagrams.

These computer program instructions may also be stored in computer readable media which can instruct computers or other programmable data processing apparatuses to work in a particular way, so that the instructions stored in computer readable media produce an article of manufacture including instruction component implementing functions and/operations specified in the blocks of the flow chart and/or block diagrams.

Computer program instructions may also be loaded to computers or other programmable data processing apparatuses such that a series of operation steps are executed on computers or other programmable data processing apparatuses so as to produce the procedure realized by computers. Therefore, the instructions executed on computers or other programmable apparatuses provide a procedure of implementing functions/operations specified in the blocks of the flow chart and/or the block diagrams.

The flow chart and block diagrams in the attached drawings illustrate system architectures, functions and operations which are possibly implemented according to systems, methods and computer program products of respective embodiments of the present invention. In this regard, each block in the flow chart or block diagrams may represent one module, program segment, or a part of codes which contain one or more executable instruction(s) for implementing specified logical functions. It should be further noted that in some alternative implementation, the functions denoted blocks may occur in a different sequence than that denoted in the attached drawings. For example, in fact, two blocks which are denoted sequentially can be executed in substantially parallel. Sometimes, they can be executed in a reverse sequence, which is decided depending on the related functions. It should be further noted that each block of the block diagrams and/or flow chart as well as combination of blocks in the block diagrams and/or flow chart may be implemented by a specific, hardware based system executing the specified functions or operations, or may be implemented by a combination of specific hardware and computer instructions.

What is claimed is:

1. A server management system for managing a plurality of servers, wherein the server management system comprises baseboard management controllers located at each server, and each of the baseboard management controllers comprises:
a connection establishment interface component that is configured to establish connection with a processing device in response to a request of establishing connection with the processing device, and to receive a server management instruction from the processing device; and
a wireless network communication component that is configured to enable the baseboard management controllers of the plurality of servers to establish a wireless network through the respective wireless network communication component;
wherein the server that establishes connection with the processing device is designated as an interface server of the server management system, and wherein the wireless network communication component of the baseboard management controller of the interface server broadcasts the server management instruction received by the connection establishment interface component to managed servers via the established wireless network.

2. The system of claim 1, wherein the wireless network communication component of the baseboard management controller of the interface server, in response to receiving a response from a managed server to the server management instruction, forwards the response to the processing device via the connection establishment interface component.

3. The system of claim 1, wherein the interface server sends the execution result of the management instruction to a designated receiver at a designated frequency in a designated way.

4. The system of claim 1, wherein the wireless network communication component on the baseboard management controllers support using one or more wireless communication protocols selected from a static wireless local area network protocol and a dynamic Personal Area Network protocol.

5. The system of claim 1, wherein the interface server establishes connection with the processing device using one or more communication protocol selected from static wireless local area network, dynamic Personal Area Network, Bluetooth, USB and infrared.

6. The system of claim 1, wherein the server management instruction comprises management content selected from a firmware update, system configuration, information collection, and combinations thereof.

7. A method for server management, wherein each of a plurality of servers has a baseboard management controller, and the baseboard management controller has a wireless network communication component, and the baseboard management controllers of the plurality of servers establish a wireless network through the wireless network communication component on them, the method comprising:
establishing, by the baseboard management controller of any one of the plurality of servers, connection with one processing device in response to a request of establishing connection with the processing device;
designating the server including the baseboard management controller that establishes connection with the processing device as an interface server; and
receiving, by the interface server, a server management instruction from the processing device, and broadcasting, by the interface server, the received server management instruction to managed servers via the established wireless network.

8. The method of claim 7, further comprising:
forwarding, in response to receiving a response of a managed server to the server management instruction, the response to the processing device.

9. The method of claim 7, further comprising:
sending by the interface server the execution result of the management instruction to a designated receiver at a designated frequency in a designated way.

10. The method of claim 7, wherein the wireless network communication component on the baseboard management controllers support one or more of wireless communication protocols as static wireless local area network protocols or dynamic Personal Area Network protocols.

11. The method of claim 7, wherein the the interface server establishes connection with the processing device using one or more communication protocol selected from static wireless local area network, dynamic Personal Area Network, Bluetooth, USB and infrared.

12. The method of claim 7, wherein the server management instruction comprises management content selected from a firmware update, system configuration, information collection, and combinations thereof.
